(19) United States
(12) Patent Application Publication
(10) Pub. No.: US 2004/0246068 A1
(43) Pub. Date: Dec. 9, 2004

(54) Coaxial line phase stabilization apparatus and method

(75) Inventor: James T. Stenberg, Portland, ME (US)

Correspondence Address: BAKER & HOSTETLER LLP, Washington Square, Suite 1100, 1050 Connecticut Avenue, N. W., WASHINGTON, DC, 20036, US

(73) Assignee: SPX CORPORATION

(21) Appl. No.: 10/452,129

(22) Filed: Jun. 3, 2003

(51) Int. Cl. H04N 5/38

(52) U.S. Cl. 333/117

(57) ABSTRACT

A phase control mechanism for broadcast RF transmission using pairs of transmission lines feeding a dual port antenna continuously monitors phase error between either the signals carried by the two lines or the physical heights of the bottom elbows where the two lines turn upward to ascend a tower. The mechanism minimizes phase error by altering the propagation time in one or both lines. Causes for such phase errors include climatic conditions such as unmatched heating by sunlight and cooling by wind. Effects of such phase errors include beam tilt and reduction in effective broadcasting range. Systems for which such phase control is applicable include broadband transmission systems carrying one or more channels of television and radiating them using a single antenna on a tower.

### FIELD OF THE INVENTION

The present invention relates generally to high-power radio frequency transmission lines. More particularly, the invention relates to an arrangement to stabilize two parallel coaxial lines, such as for example signal lines extending vertically and supported by a transmission tower.

### BACKGROUND OF THE INVENTION

It is known in antenna systems to have two parallel coaxial lines extending vertically upward along a tower. These coaxial lines each include, for example, up to 2,000 feet of coaxial tubing in sections, forming a coaxial line fixed to the tower at the top of the line, so that the line is suspended from its top end.

Both coaxial lines may be suspended at points along their length by spring hangers from the tower to allow the coaxial lines to expand and contract with respect to the tower. The spring hangers provide stability while permitting vertical travel of the line relative to the tower due to factors such as thermal expansion of the line relative to the tower.

The coaxial line and the tower are commonly made of different materials. For example, the coaxial line may be made of copper and the tower made of steel. Since such metals have different thermal coefficients of expansion, there can be a differential in the thermally induced growth of the copper coaxial line with respect to the steel tower as the temperature and the operating power of the coaxial line change.

For this reason, it is known to suspend the coaxial lines from the top of the tower, so they are fixed both vertically and horizontally at the top of the coaxial line to the tower, but are essentially hanging suspended from the top, with the lines horizontally restrained by spring hangers and guide sleeves that permit vertical movement along the length of the line. This permits the length of the line to have vertical travel, while the lower ends of the coaxial lines, which typically terminate in elbows connecting to horizontal coaxial line sections, are free to travel vertically relative to the tower.

A disadvantage of the known arrangement is that one of the two parallel coaxial lines may expand at a different rate than the other. For example, if one coaxial line is heated by the sun and the other coaxial line is in the shade, the first coaxial line will expand at a different rate than the second coaxial line. The differential in linear expansion between two adjacent coaxial lines can cause a phase difference in the transmission of signals transmitted through the lines, which can result in undesirable beam tilt in the signal radiated by the antenna. That is, if the two coaxial lines expand to a different extent along their length, the distance from the lower elbows to the fixed top portions of the lines where they join the antenna will be a different total distance, and the effective and actual transmission lengths of the two lines will be different from each other. The change in relative length is undesirable because the signals at the top of the coaxial lines will be out of phase due to having traveled different distances, whereas two lines are intended to carry signals that are in phase.

Using two transmission lines in place of one single, larger line that can have the same current carrying capacity may obtain certain advantages. The intrinsic redundancy in a two-line configuration may represent a deciding factor. Feed simplicity to a dual-port antenna, which is a known type of high-power, broadband antenna for multichannel UHF television broadcasting, may be a consideration. In some instances, the second transmission line may have been installed later, and may have represented the safest and most cost-effective means for adding to the carrying capacity of a tower.

An example of a practical use for two separate transmission lines on a tower is to drive a dual-feed antenna, which is substantially an array of two sub-antennas, where each sub-antenna accepts the full power of one transmission line, and where, as long as the two sub-antennas are fed with synchronous and in-phase signals, the radiation patterns of the two sub-antennas reinforce to increase the effective range at which a signal can be received. A system using a dual-feed antenna may typically transmit a single beam, substantially uniform in all directions around the tower, with the highest signal strength occurring parallel to the plane of the earth.

Any difference in phase between the two signals from the two transmission lines to the two sub-antennas comprising the dual-feed antenna can cause the two radiation patterns to separate, so that an increased proportion of the transmitted power is directed above and below the horizon. Such a phase difference can have the effect of lowering the signal strength detected at the most distant points where the signal can be received, and thus of effectively reducing broadcasting range without reducing power expenditure.

In a system without phase stabilization, phase error between the signals fed with dual transmission lines to a dual-feed antenna can vary during the course of a day and the course of a year. Air temperature at each increment of height can be the same for both transmission lines, and the power level applied to both lines can likewise be substantially the same at most times, both of which factors affect the temperature and thus the length of the transmission lines. However, the effects of wind and sun can establish an appreciable temperature difference between the two transmission lines, and can cause up to several inches of difference in length between the two lines, which corresponds to many degrees of phase error. This phase error can cause signal strength to vary with time of day and by season, most noticeably at the limits of broadcast range.

Accordingly, there is a need for an arrangement that can tie together a pair of parallel coaxial lines and accommodate differential expansion between sections of the adjacent lines, maintaining in effect a constant total length for the lines, such as for example, between a lower elbow and a fixed top end of each line.

### SUMMARY OF THE INVENTION

In accordance with one embodiment of the invention, a sensing apparatus detects the lengths of the two signal paths and a phase adjustment mechanism alters the relative effective lengths of the signal paths dynamically to maintain the difference between the paths below a threshold.

In accordance with another embodiment of the invention, an RF broadcast system is comprised of two substantially equal transmission lines capable of carrying RF broadcast signals from a transmitter site to a location on a tower or equivalent elevated structure; a dual-feed antenna affixed to a tower or equivalent elevated structure, which antenna can radiate RF broadcast signals; a phase measurement subsystem; a phase measurement translation and control subsystem, hereinafter termed a control subsystem; and a phase adjuster subsystem incorporated into the signal paths of the two transmission lines. This RF broadcast system is further comprised of a content source, such as one or more signals, with audio and video content modulating RF carriers, or digital content modulating RF carriers; a distribution device to distribute the content source signals to one or more amplifiers; and one or more amplifiers to amplify the content source signals to levels sufficient for broadcast.

In accordance with another embodiment of the invention, an apparatus provides means for carrying high-power RF broadcast signals for at least one content source on two separate signal paths on a tower, means for detecting the phase relationship associated with the difference between the lengths of the two signal paths, and means for converting the phase relationship into a command for altering the relative electrical propagation path lengths of two signal paths.

In accordance with still another embodiment of the invention, an apparatus provides means for detecting the difference in height between the bottoms of two vertical signal paths, means for converting the measured height differences between the two signal paths into a phase difference value, and means for converting the phase difference into a command for altering the relative electrical propagation path lengths of two signal paths.

In accordance with yet another embodiment of the invention, a method of maintaining a low-error phase relationship between synchronous high-power RF broadcast signals comprises the steps of sending RF signals along two separate transmission lines terminating in RF radiators characterized by appreciable reflections, detecting the reflected RF signals as returned to a point near the source, computing the phase differential between the two detected reflected signals, translating the phase differential into a correction factor, evaluating the correction factor to determine whether it exceeds an action threshold, and altering the system configuration by changing the electrical length of an element thereof to reduce the phase differential below the action threshold, in those cases where the action threshold is exceeded.

There have thus been outlined, rather broadly, the more important features of the invention, in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram of a broadcast system incorporating a preferred embodiment of the control system.

FIG. 2 is a schematic diagram of a phase stabilization system incorporating an acoustical-pulse-based embodiment of the control system.

FIG. 3 is a schematic diagram of a phase stabilization system incorporating a VSWR-sensor-based embodiment of the control system.

FIG. 4 is a schematic diagram of a second VSWR-sensor-based phase stabilization embodiment with a reduced component count.

FIG. 5 is a schematic diagram of a phase stabilization system incorporating an out-of-channel-RF-based embodiment of the control system.

FIG. 6 is a schematic diagram of a phase stabilization system with the sensors located at the antenna end of the transmission lines.

### DETAILED DESCRIPTION OF THE INVENTION

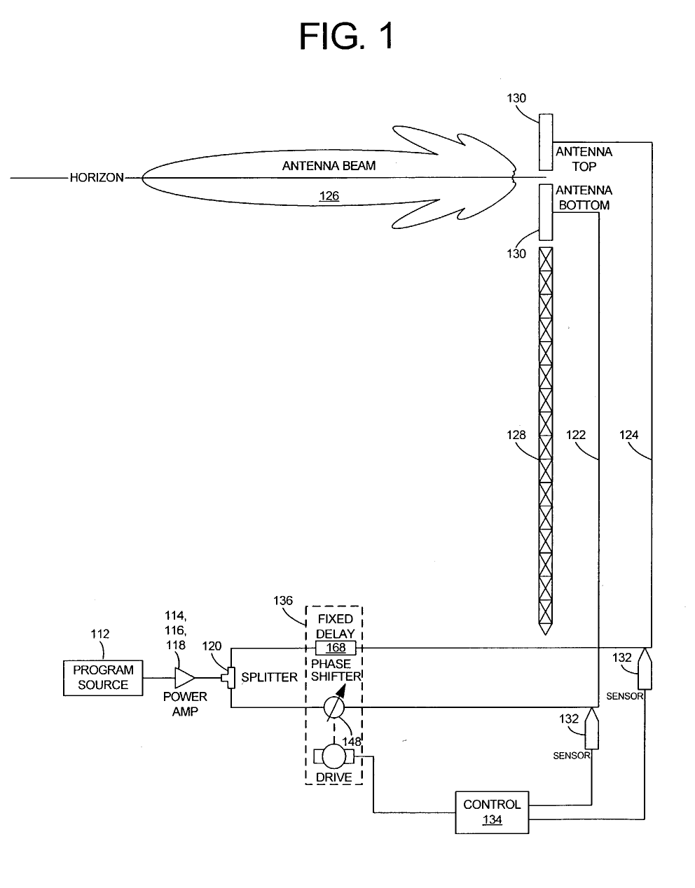

In one aspect of the inventive apparatus and method, as shown in schematic diagram form in FIG. 1, an RF broadcast system 110 using dual transmission lines comprises a program source 112, such as one or more continuous, low-power signals from a television studio, each of which may have audio, video, and an RF carrier, or may have digital content with an RF carrier; a distribution device 114 to distribute the program source signal; one or more amplifiers 116; sufficient combiners 118 to collect the signals from all of the amplifiers into a single, high-level signal for broadcast; a splitter 120 to divide the high-level signal into two substantially equal signals; a first transmission line 122 and a second, substantially equal transmission line 124 to carry the signals to an assigned location such as the top of a tower or equivalent elevated structure 128; and a dual-feed antenna 130 that can radiate the broadcast signals 126. To this system the preferred embodiment adds a measuring subsystem 132, a control subsystem 134, and a phase adjuster subsystem 136.

In a typical system, as shown in FIG. 1, the vertical length of the transmission lines 122 and 124 up the tower 128 to the antennas 130 is greater than the remainder of the line length to an extent sufficient to allow the horizontal run to be uncompensated and produce satisfactory results. In some instances a sun shield can further enhance uniformity of thermal conditions for the horizontal sections.

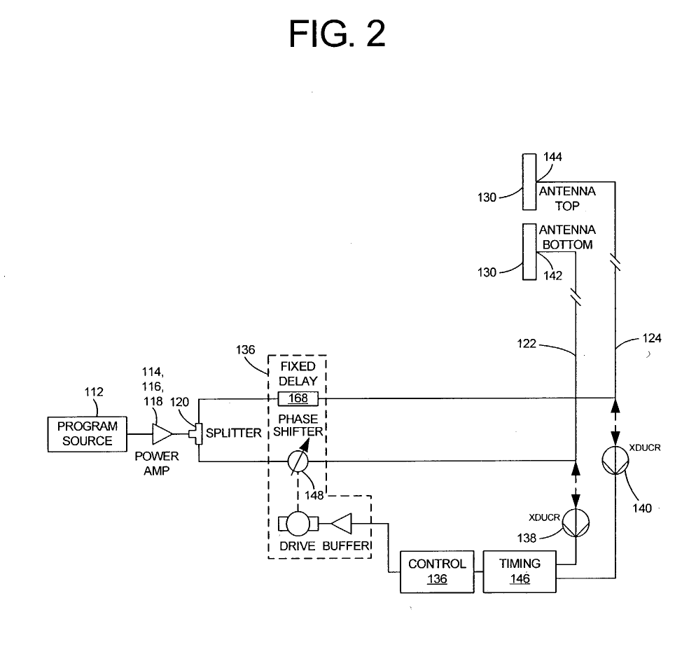

FIG. 2 shows, in schematic diagram form, one embodiment of a stabilization subsystem. For this embodiment, a paired electronic measuring instrument, using a technology such as acoustical or optical pulse gauging, can measure the distance from a reference surface, preferably near the bottom of the tower, to a pair of reference points located near and attached to the bottoms of the vertical portions of the first and second transmission lines 122 and 124, respectively.

First and second bidirectional transducers 138 and 140, respectively, which can use such technologies as acoustical or optical pulse gauging, are shown in this embodiment. The time required for the pulses propagate from the transducers 138 and 140 to the reference points and to return may be measured with electronic timing circuitry 146. Assuming that the heights of the tops of the transmission lines relative to each other are fixed at the dual ports 142 and 144 of the antenna 130, the difference in propagation times between the two gauging signals can be proportional to the difference in the vertical lengths of the transmission lines 122 and 124. The difference in propagation times can be compared to previous differences, and any change can produce a correction term. The correction term can be introduced into a phase shifter 148 to change the total time delay for one of the signal paths, effectively compensating for the dimension difference.

Setup for such a system may require measuring the output phase at the tower top for different phase shifter settings with test transitions during system installation and alignment. Alternatively, a temporary short circuit can be placed on the end of the line and round trip phase measured. This method also quantifies the insertion loss as built, potentially identifying system defects.

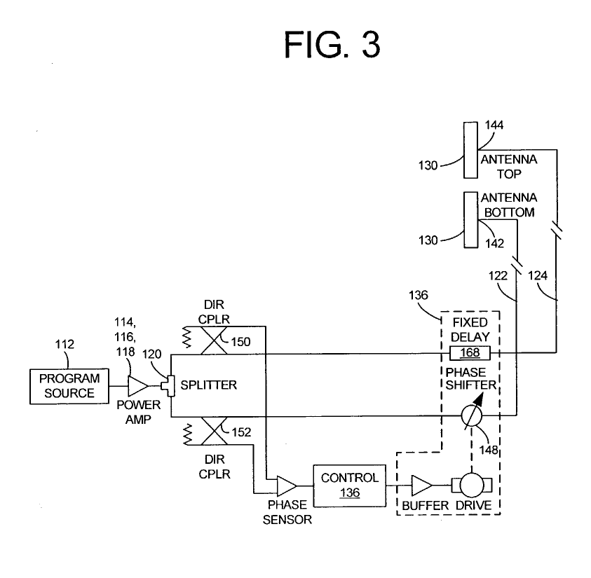

FIG. 3 shows a schematic diagram of a second embodiment of a stabilization subsystem. For this embodiment, use is made of a pair of voltage standing wave ratio (VSWR) directional couplers 150 and 152, which are positioned in the signal path. Each coupling between sections of coaxial line or waveguide in a transmission line is known to display a—typically small—impedance discontinuity. The discontinuities manifest as reflections at directional couplers associated with transmitters. The largest discontinuities in a properly operational system, and hence the strongest reflected signals, are generally associated with the ports 142 and 144 of the dual-feed antenna 130. Thus the largest signals on the directional couplers 150 and 152 can represent RF broadcast signals that have traveled the length of the transmission lines 122 and 124, reflected off the antenna ports 142 and 144, and returned, for a total travel of twice the length of the transmission lines. A phase comparison between these returning signals can thus be an accurate gauge of the phase error at the antenna ports 142 and 144. A corrective delay can be inserted between one of the directional couplers and the corresponding antenna port with a phase shifter 148, so that the excess delay caused by the difference in propagation distances will be countered by the delay inserted with the phase shifter 148. This embodiment can allow the phase detection circuit to give a direct reading, which can indicate a null when the propagation times to the antenna ports 142 and 144 are equal.

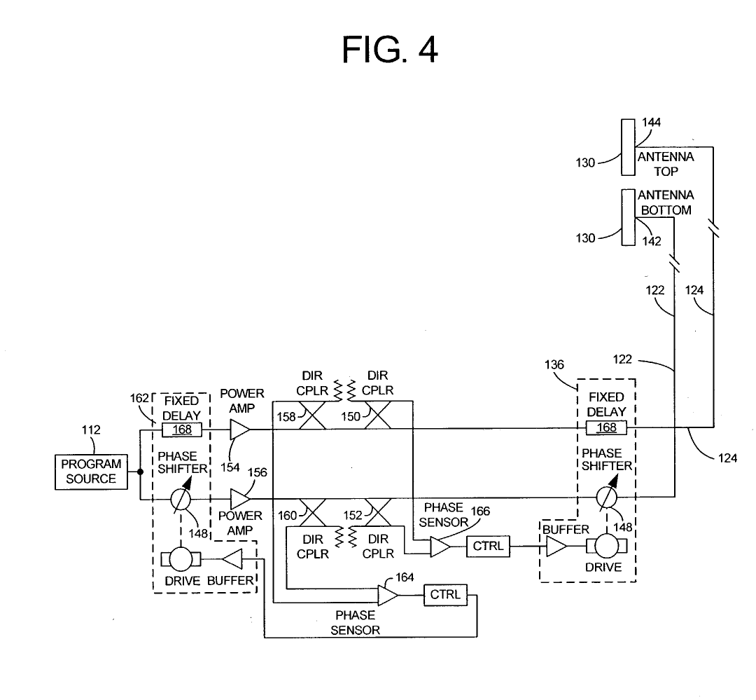

FIG. 4 shows a schematic diagram of a third embodiment, a variation on the second embodiment, that can reduce system complexity by omitting the last combiner and the splitter 120 used to synchronize the signals entering the two transmission lines 122 and 124. In this embodiment, a low-power phase shifter 162 feeds the two amplifiers 154 and 156, and the amplifier outputs feed the two transmission lines 122 and 124 by way of at least two directional couplers in each line, one forward 158 and one reverse 150 in the first line, and one forward 160 and one reverse 152 in the second line. The forward couplers 158 and 160 on the two lines can be connected to a phase sensor 164 that can in turn control the low-power input phase shifter 162 to synchronize the transmitter outputs, while the reverse couplers 150 and 152 on the two lines 122 and 124 can be connected to another phase sensor 166 that controls the high-power output phase shifter 148 in the transmission line path to the antenna ports. The low power phase shifter 162 is shown as a motor driving a mechanical device, although such a function can be embodied alternatively using a solid-state electronic device. In another variation on this embodiment, the phase of the two amplifiers 154 and 156 can be synchronized manually, eliminating the control loop that operates the phase shifter 162.

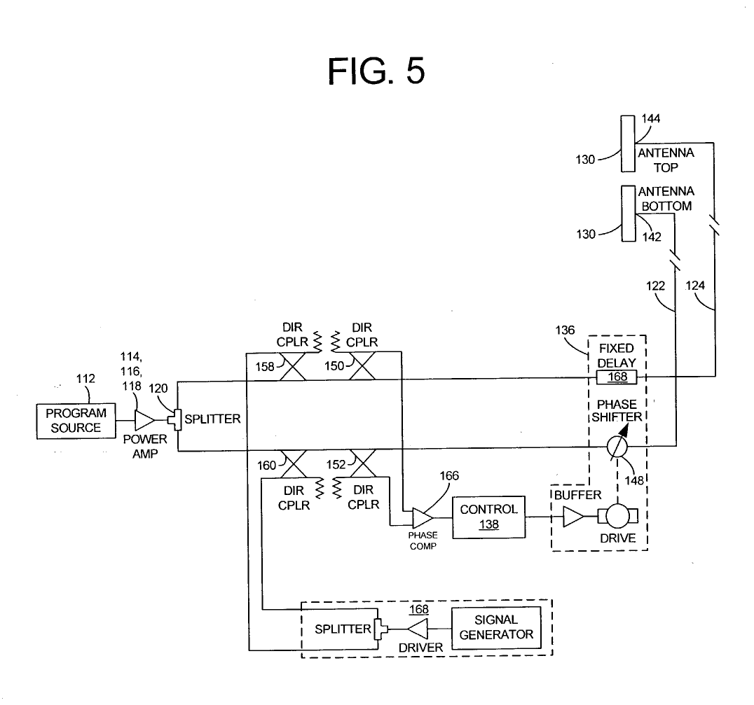

FIG. 5 shows a schematic diagram of a fourth embodiment, in which an alternative RF signal, injected at the forward directional couplers 158 and 160, travels up and down the transmission lines 122 and 124, and is detected by the reverse directional couplers 150 and 152. As in the previous embodiment, an error term related to the phase difference between the signals is extracted using a phase sensor 166 that then drives the phase shifter 148 to correct for the phase error. The distinctive attribute of this embodiment is that it can use a low-power signal at a frequency far off from the broadcast signals. In applications where the broadcasting system is broadband, such as where several channels are combined, and several programs are carried up the two transmission lines 122 and 124 to a broadband dual-feed antenna 130, the RF signal used for measuring can be far enough away in frequency from the broadcast signals to be rejected by the broadband antenna 130 and reflected back down the transmission lines 122 and 124 without depending on coupling mismatches between the transmission lines 122 and 124 and the antenna ports 142 and 144 to produce the reflections.

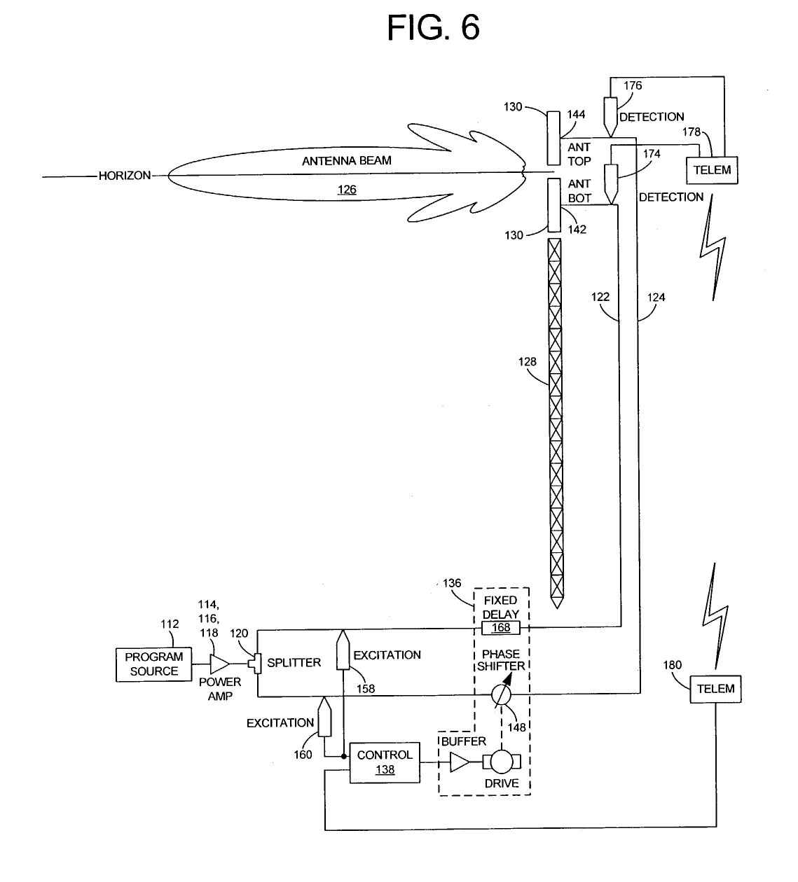

FIG. 6 shows a schematic diagram of a fifth embodiment, in which an auxiliary RF signal from the embodiment of FIG. 5 or a sample of one of the transmitted RF signals from the embodiment of FIG. 4 is detected at the top of the tower 128 by detectors 174 and 176, at the transmission lines 122 and 124 or in the air near the separate radiators comprising the antenna 130. The phase information is then extracted and transmitted by a telemetry link 178. The phase measurement signal or signals, in digital or analog form, raw or already reduced to a phase difference value, is received with a telemetry receiver 180 at the bottom of the tower 128, and is used to adjust the phase shifter 148 in the same fashion as in the other embodiments. The primary distinction in this embodiment is the direct sampling of an as-transmitted signal rather than a reflection off the antenna junctions. Furnishing of power to any active components in the sampling and telemetering apparatus at the top of the tower 128 and sending the signal thus generated back to the point at which it is used to control transmitted phase are tasks in this embodiment not shared by the others described herein.

Each of the embodiments shown in FIGS. 2-6 can use a single fixed delay 168 in a first one of their transmission lines and an adjustable phase shifter 148 in a second one of their transmission lines, so that the second line can be delayed more or less than the first line as required to satisfy the detection and correction circuitry. A functionally equivalent embodiment for each can use an adjustable phase shifter in each transmission line, and can, for example, command whichever phase shifter is needed to advance from its minimum-delay position.

The embodiments described above are suitable to a greater or lesser extent to many RF systems, but are addressed expressly to the ultra-high frequency (UHF) band and above, where phase shifters, combiners, directional couplers, and splitters employing waveguide technology can be readily applied. Similar systems in the very high frequency (VHF) band require embodiments based on coaxial line structures or extremely large waveguides, unusual in the art. Antenna radiation patterns for VHF are also less affected than are those for UHF by transmission line dimension variations in the range described.

The embodiments are described in terms most directly applicable to the use of coaxial lines, but in many instances waveguide can be used for a greater or lesser portion of the signal paths indicated. Particularly for systems in which UHF transmissions at moderate to high power are required, so that the power capacity of a single waveguide may be exceeded, the sharing and synchronizing process described can enable an effective system realization.

The many features and advantages of the invention are apparent from the detailed specification; thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to that fall within the scope of the invention.

What is claimed is:

1. An RF broadcast system, comprised of:
two substantially equal transmission lines capable of carrying RF broadcast signals from a transmitter site to a location on a support structure;
an antenna affixed to the support structure, that radiates RF broadcast signals from a plurality of sources, fed by independent transmission lines;
a phase adjuster subsystem configured to increase and decrease the relative electrical lengths of the signal paths of said two transmission lines.

2. The RF broadcast system of claim 1, wherein the system further comprises:
a content source providing continuous, low-power signals with audio, video, digital, and other programming content modulating RF carriers;
one or more amplifiers to amplify said content source signals to levels sufficient for broadcast; and
a distribution device to distribute the content source signal among said amplifiers.

3. The RF broadcast system of claim 1, wherein said antenna further comprises ports for two substantially equal RF signals.

4. The RF broadcast system of claim 1, wherein the system further comprises a phase measurement subsystem configured to detect a phase difference in the signals on the two transmission lines and convert the difference into an electrical signal with a property proportional to the phase difference.

5. The RF broadcast system of claim 1, wherein the system further comprises:
a first distance measurement apparatus that translates into an electrical signal a first height measurement from the lowest point of a first vertical transmission line run on a tower upon which is mounted said dual-port antenna to a first reference surface;
a second distance measurement apparatus that translates into an electrical signal a second height measurement from the lowest point of a second vertical transmission line run on a tower upon which is mounted said dual-port antenna to the first reference surface; and
a computational device that can interpret the electrical signals from said first and second distance measurement apparatuses as an electrical signal proportional to a phase difference.

6. The RF broadcast system of claim 1, wherein the system further comprises:
a phase measurement translation and control subsystem fed with an electrical signal proportional to a phase difference and outputting electrical signals constituting commands for the control of RF phase in the signals radiated by said antenna; and
a phase adjuster subsystem controlled by control signals from said phase measurement translation and control subsystem.

7. The RF broadcast system of claim 1, wherein the system further comprises an RF signal source to permit phase measurement, where said RF signal source furnishes an RF signal substantially outside the frequency range at which said antenna can radiate readily.

8. The RF broadcast system of claim 1, wherein the system further comprises:
a plurality of phase-sensitive signal detectors located in the vicinity of the RF broadcast antenna;
a signal processing device configured to convert the detected signals into phase-preserved information that can be transmitted;
a signal transmitter that transmits the phase-preserved information to a receiver;
a signal receiver that receives the phase-preserved information; and
a processor that converts the phase-preserved information into a control signal capable of actuating said phase adjuster subsystem.

9. The RF broadcast system of claim 1, wherein the system further comprises:
a plurality of phase-sensitive signal detectors located in the vicinity of the RF broadcast antenna;
a signal processing device that converts the detected signals into a phase control signal that can be transmitted;
a signal transmitter that transmits the phase control signal to a receiver;
a signal receiver that receives the phase control signal; and
a processor that converts the parameters of the phase control signal for actuating said phase adjuster subsystem.

10. The RF broadcast system of claim 2, wherein the number of amplifiers is at least two, and said distribution device includes:
a phase delay insertion device located in the signal path to at least all but one of said amplifiers; and
an adjustment feature in each of said phase delay insertion devices.

11. The RF broadcast system of claim 10, wherein the phase delay exhibited by said delay device is a function of an externally applied command in the form of an electrical signal.

12. The RF broadcast system of claim 2, wherein the system further comprises:
at least one combiner to collect the signal outputs from said amplifiers into a single, high-level signal for broadcast; and
a splitter to divide the combined high-level signal into two substantially equal signals.

13. The RF broadcast system of claim 2, where the system further comprises a plurality of combiners to collect the signals from all of said amplifiers into two substantially equal high-level signals for broadcast.

14. The RF broadcast system of claim 1, wherein a difference in phase between two arriving signals of otherwise equivalent content produces a signal output proportional to the magnitude and polarity of the phase differences between the signals over the range of phase variation of which the transmission line subsystem is capable.

15. The RF broadcast system of claim 1, wherein a difference in phase between a first arriving signal and a second arriving signal of otherwise equivalent content produces a signal output representing the phase difference between the first and second signals, and consisting of one of the states A, B, and C, where the A state represents a condition where the first lags the second, the B state represents a condition where the first and the second are equal within a range, and the C state represents a condition where the first leads the second.

16. The RF broadcast system of claim 1, wherein a signal received by the control subsystem from the phase measurement subsystem, which signal corresponds to a condition where the signal impressed on the first transmission line exhibits a net lag exceeding a threshold with respect to the signal impressed on the second transmission line, produces a control subsystem output comprising a command to said phase adjuster subsystem to alter the phase thereof to reduce the net lag.

17. The RF broadcast system of claim 1, wherein a signal received by the control subsystem from the phase measurement subsystem, which signal corresponds to a condition where the signal impressed on the first transmission line exhibits a net lead exceeding a threshold with respect to the signal impressed on the second transmission line, produces a control subsystem output comprising a command to said phase adjuster subsystem to alter the phase thereof to reduce the net lead.

18. The RF broadcast system of claim 1, wherein said subsystem further comprises:
a first phase shifting apparatus capable of shifting the phase of a high-level RF signal in a first transmission line by a fixed amount; and
a second phase shifting apparatus capable of shifting the phase of a high-level RF signal in a second transmission line by an adjustable amount.

19. The RF broadcast system of claim 18, wherein the adjustment range of which said apparatus is capable includes the fixed phase shift amount of the first shifting apparatus of claim 18 and a roughly equal range of phase shift greater than and less than that amount.

20. The RF broadcast system of claim 1, wherein said subsystem further comprises:
a first phase shifting apparatus capable of shifting the phase of a high-level RF signal by an adjustable amount; and
a second phase shifting apparatus capable of shifting the phase of a high-level RF signal by an adjustable amount roughly equal to the range of said first phase shifting apparatus.

21. The RF broadcast system of claim 1, wherein the differential phase adjustment range of said subsystem exceeds the range of phase variation of which the transmission line subsystem is capable.

22. The RF broadcast system of claim 1, wherein said phase adjuster subsystem responds to an applied command signal by activating a mechanism that alters the amount of phase shift inserted by said phase adjuster subsystem into the signal path of which it comprises a part in proportion to the polarity and the time duration of the command signal.

23. The RF broadcast system of claim 1, wherein said phase adjuster subsystem responds to an applied command signal by activating a mechanism that alters the amount of phase shift inserted by the phase adjuster subsystem into the signal path of which it comprises a part at a rate in proportion to the polarity and the magnitude of the command signal.

24. An RF broadcast system, comprising:
means for carrying high-power RF broadcast signals on two separate signal paths on a tower;
means for detecting the phase relationship associated with the difference between the electrical lengths of the two signal paths; and
means for converting the phase relationship into a command for altering the relative electrical propagation path lengths of two signal paths.

25. An RF broadcast system, comprising:
means for detecting the difference in height between the bottoms of two vertical signal paths;
means for converting the measured height differences between the two signal paths into a phase difference value; and
means for converting the phase difference into a command for altering the relative electrical propagation path lengths of two signal paths.

26. A method of maintaining a low-error phase relationship between synchronous high-power RF broadcast signals, comprising the steps of:
sending RF signals along two separate transmission lines terminating in RF radiators characterized by appreciable reflections;
detecting the reflected RF signals as returned to a point near the source;
computing the phase differential between the two detected reflected signals;
translating the phase differential into a correction factor;
evaluating the correction factor to determine whether it exceeds an action threshold; and
altering the system configuration by changing the electrical length of an element thereof to reduce the phase differential below the action threshold, in those cases where the action threshold is exceeded.
